(19) United States
(12) Patent Application Publication
(10) Pub. No.: US 2013/0319963 A1
(43) Pub. Date: Dec. 5, 2013

(54) Display and Packaging Systems and Methods

(71) Applicants: Matthew Coon, Cherry Hill, NJ (US); Walter Spade, IV, West Deptford, NJ (US); Robert Fuerst, Philadelphia, PA (US); Daniel Forster, Sanatoga, PA (US); Michael Macchi, Yardley, PA (US); Allen Friedman, Bensalem, PA (US)

(72) Inventors: Matthew Coon, Cherry Hill, NJ (US); Walter Spade, IV, West Deptford, NJ (US); Robert Fuerst, Philadelphia, PA (US); Daniel Forster, Sanatoga, PA (US); Michael Macchi, Yardley, PA (US); Allen Friedman, Bensalem, PA (US)

(73) Assignee: Tri-State Container Corporation, Bensalem, PA (US)

(21) Appl. No.: 13/683,079

(22) Filed: Nov. 21, 2012

Related U.S. Application Data
(60) Provisional application No. 61/563,205, filed on Nov. 23, 2011.

(51) Int. Cl. A47F 5/11; B31B 5/00

(52) U.S. Cl. CPC A47F 5/116; B31B 5/00; A47F 5/114
USPC 211/149; 493/51

(57) ABSTRACT

The invention provides a packaging and display box that can be bundled and transported in an unassembled, compact blank. The packaging and display box can be quickly, easily, and conveniently assembled into a structurally and functionally stable display and deployed for commercial use. The packaging and display box can contain and display a variety of merchandise, including, but not limited to, packaged food products, consumer products, and the like. The packaging and display box provides modularity so that several assembled boxes can be stacked into a multi-box display that is also structurally and functionally stable. The invention also provides methods and systems for using the packaging and display box.

### CROSS REFERENCE TO RELATED APPLICATION

This application claims the priority and benefit of U.S. Provisional Patent Application Ser. No. 61/563,205, entitled “Display and Packaging Systems and Methods,” filed Nov. 23, 2011, the entirety of which is incorporated herein by reference.

### FIELD OF INVENTION

The present invention generally relates to improvements in the structure and configuration of packaging and display systems for merchandise.

### BACKGROUND OF THE INVENTION

Manufacturers, merchants, and retailers use packaging and display systems to shelve and present merchandise for sale in stores. Display systems are used at locations, including, but not limited to, grocery stores, convenient marts, gas stations, retail stores and outlets, and the like. Some existing displays are permanent shelving units while others are temporary and offer the convenience of moving the display to locations in a store that places merchandise in plain view for consumers. For example, a temporary display—which is any display that is not considered an installed store fixture such as those seen in a grocery store aisle—offer the ability for retailers and merchants to display merchandise, including, but not limited to, items being sold at the retail price or on sale. Temporary displays may be deployed in a conspicuous store location, such as, on an end cap of a permanent display, in a stand alone display, as a weekender, or other convenient store location that helps promote the sale of the displayed merchandise.

Temporary displays allow merchants and retailers to place merchandise in clear, plain view so that consumers can easily view displayed merchandise. This form of display promotes purchasing decisions in the absence of a consumer's view being encumbered by numerous products stacked on aisle shelves. In other words, temporary displays entice consumers to view and purchase products that they might not otherwise purchase if displayed on traditional aisle displays. Temporary displays can be conveniently moved by merchants and retailers.

Many contemporary display systems present drawbacks. For example, existing display systems can be costly to manufacture, cumbersome and costly to transport, commercially-unacceptable failure rates, and difficult to assemble and disassemble.

There is a need for an improved packaging and display system for showing products offered for sale at retail and merchant locations in such a way that (a) the packaging and display box can be bundled and transported in a compact unassembled form, (b) the packaging and display box can be quickly and conveniently assembled into a structurally and functionally stable display and deployed for commercial use, (c) the packaging and display box can contain and display a variety of consumer merchandise, including, but not limited to, packaged food products, general consumer products, and the like, (d) the system provides modularity so that multiple assembled packing and display boxes can be stacked into a large display that is also structurally and functionally stable, (e) is efficiently and inexpensively manufactured, and (f) functions as a custom display branded with marketing and advertising graphics which are specific for a manufacturer, retailer, or merchant.

### BRIEF DESCRIPTION OF THE DRAWINGS

Additional aspects, features, and advantages of the invention, both as to its structure, assembly, and use, will be understood and will become more readily apparent when the invention is considered in light of the following description of illustrative embodiments made in conjunction with the accompanying drawings, wherein:

FIG. 1 shows an embodiment of a cardboard blank for a packaging and display box which when assembled will have one side opening.

FIG. 2 shows another embodiment of a cardboard blank for a packaging and display box which when assembled will have two side openings.

FIG. 3 shows a further embodiment of a cardboard blank for a packaging and display box which when assembled will have four side openings.

FIG. 4a shows the blank of FIG. 2 in the beginning phase of assembly.

FIG. 4b shows the blank of FIG. 2 with its side panels being rotated inward to the central aspect of the packaging and display box.

FIG. 4c shows the blank of FIG. 2 with the ends of the side panels being secured to the packaging and display box.

FIG. 4d shows the blank of FIG. 2 fully assembled.

FIG. 5a shows the blank of FIG. 3 in the beginning phase of assembly.

FIG. 5b shows the blank of FIG. 3 with the end of one side panel secured to the packaging and display box.

FIG. 5c shows the blank of FIG. 3 fully assembled.

FIG. 5d shows several unassembled blanks of FIG. 3 secured in a bundle.

FIG. 6 shows a stack of five packaging and display boxes assembled from blanks embodied in FIG. 3.

FIG. 7 shows an alternative embodiment of a cardboard blank for a packaging and display box which when assembled will have two side openings.

FIG. 8 shows an insert for a packaging and display box.

### DETAILED DESCRIPTION OF EMBODIMENTS OF THE INVENTION

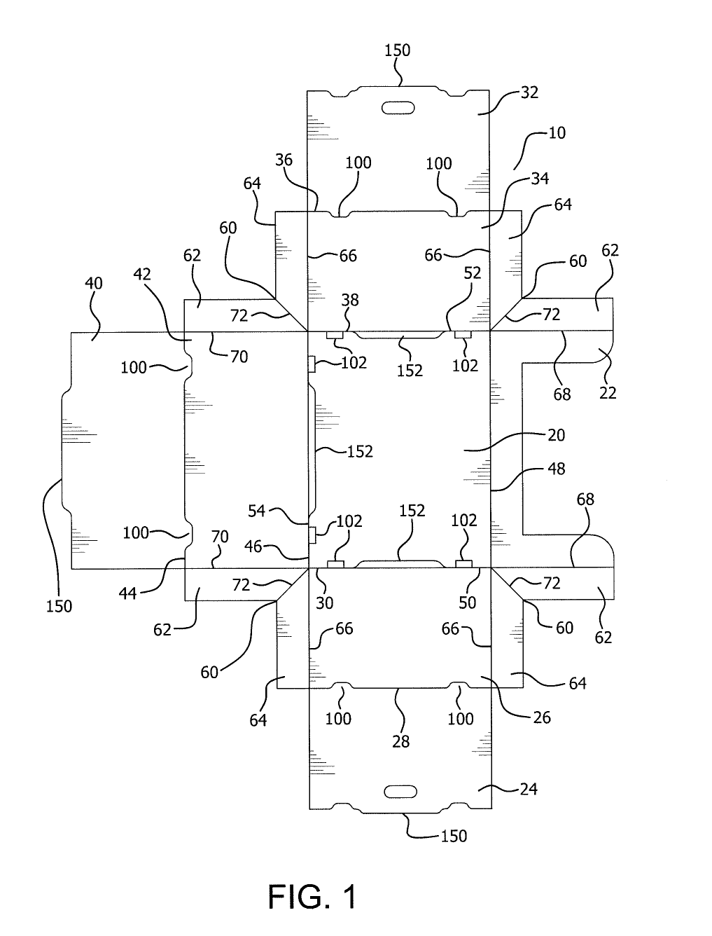

Illustrative and alternative embodiments of a packaging and display system for merchandise will be discussed in detail, as follows, with reference to FIGS. 1-8 as provided with this application. The invention provides an improved packaging and display system for merchandise.

A purpose of the invention is to provide a packaging and display box 10 that can be bundled and transported in an unassembled form that is compact. Another purpose of the invention is to provide a packaging and display box 10 that can be quickly and conveniently assembled into a structurally and functionally stable display and deployed for commercial use. Yet another purpose of the invention is to provide a packaging and display box 10 that can contain and display a variety of merchandise, including, but not limited to, packaged food products, consumer products, and the like. An even further purpose of the invention is to provide modularity so that several assembled packaging and display boxes 10 can be stacked into a multi-box display that is also structurally and functionally stable. Yet an even further purpose of the invention is to provide a system that can be efficiently and inexpensively manufactured.

An illustrative embodiment of the invention—a display system comprising a box-like configuration without a top—is described. Generally, the display system comprises box 10 provided in several different embodiments. Although similar aspects of the embodiments of the invention are featured throughout this disclosure and are readily apparent, these similarities will be repeated, as needed, in context with the variations of each embodiment.

Referring to FIGS. 1-3 and 7, box 10 may be assembled from a blank. The blank may be prepared so that box 10 comprises between one to four openings provided in the front, sides, and rear of box 10. The blank may be prepared by die cutting—or other suitable process—corrugated cardboard into any form of the embodiments of blanks shown. The corrugated cardboard may comprise any paper gauge, flute, and grade. The cardboard may be any one or combination of single, double, or triple walled cardboard so long as the selected gauge, flute, and grade cardboard provides a structurally sound material that is foldable and retains the functions as contemplated by the invention. In alternative embodiments, the blank may comprise plastic material or other suitable material that provides structural support to the display system similar to the cardboard material.

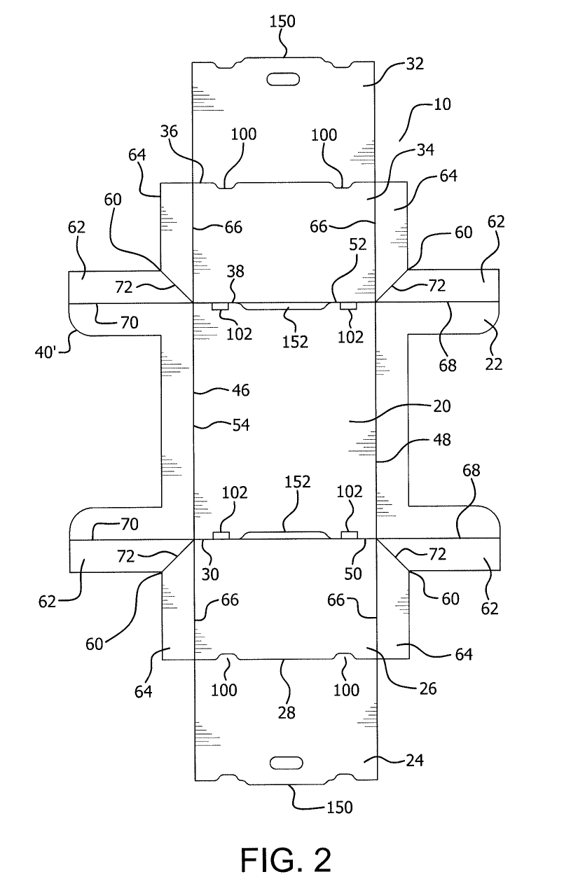

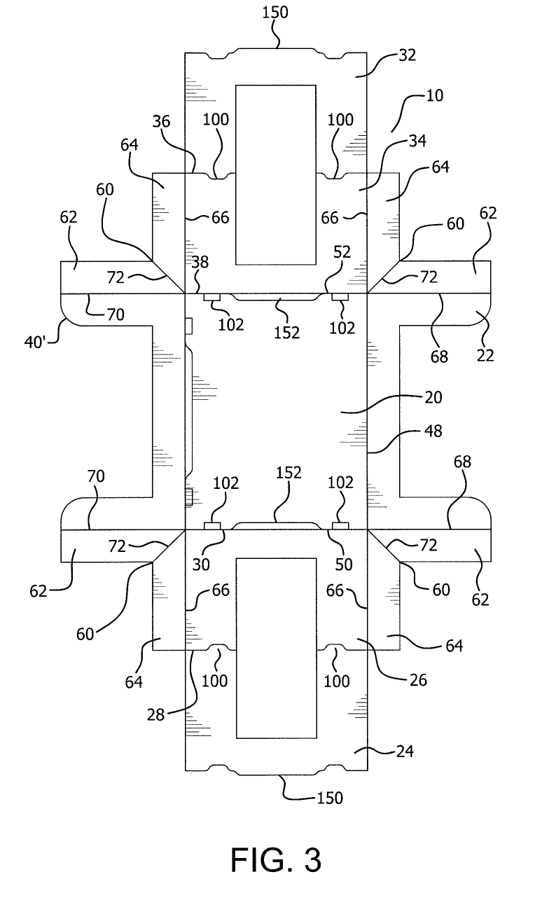

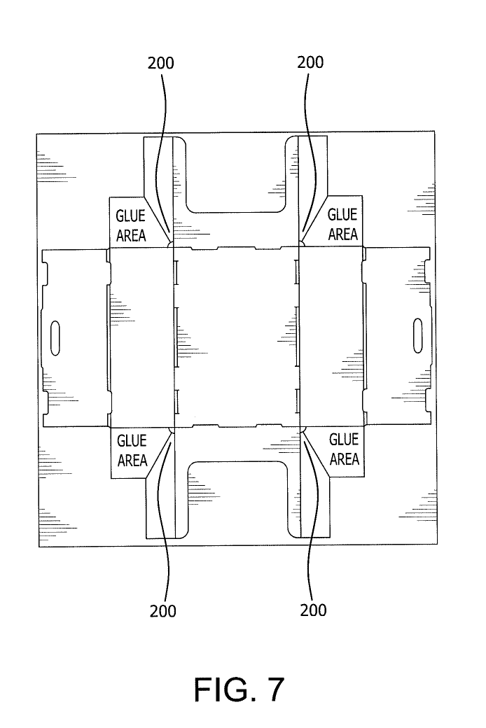

The invention provides embodiments of a blank for box 10 having one opening (FIG. 1), two openings (FIGS. 2 and 7), three openings (i.e., in the front and side panels), and four openings (FIG. 3) along panels of box 10 with the exception of bottom panel 20. Throughout these embodiments, bottom panel 20 is contiguous along (a) scored fold line 30 with inner portion of left side panel 26, (b) scored fold line 38 with inner portion of right side panel 34, (c) scored fold line 46 with inner portion of rear panel 42 (of FIG. 1) or rear panel 40′ (of FIGS. 2 and 3), and (d) scored fold line 48 with front panel 22. All scored fold lines referred to in this application provide uniform linear edges when any form of blank is assembled into box 10.

Referring to FIGS. 1-3 and 7, box 10 comprises four L-shaped arms 60 each having a first arm 62 and a second arm 64. L-shaped arms 60 are shown adjacent front panel 22, inner portion of left side panel 26, inner portion of right side panel 34, and inner portion of rear panel 42 (FIG. 1) or rear panel 40′ (FIGS. 2 and 3). Scored fold lines 66 are provided between L-shaped arms 60 and the inner portions of side panels 26, 34. Scored fold lines 68 are also provided between L-shaped arms 60 and front panel 68. Scored fold lines 70 are similarly provided between L-shaped arms 60 and inner portion of rear panel 42 (FIG. 1) or rear panel 40′ (FIGS. 2 and 3). L-shaped arms 60 each comprise angular score line 72 which provides an accordion-like fold when the blank is pre-assembled in a form that can be bundled and/or transported before final assembly of box 10.

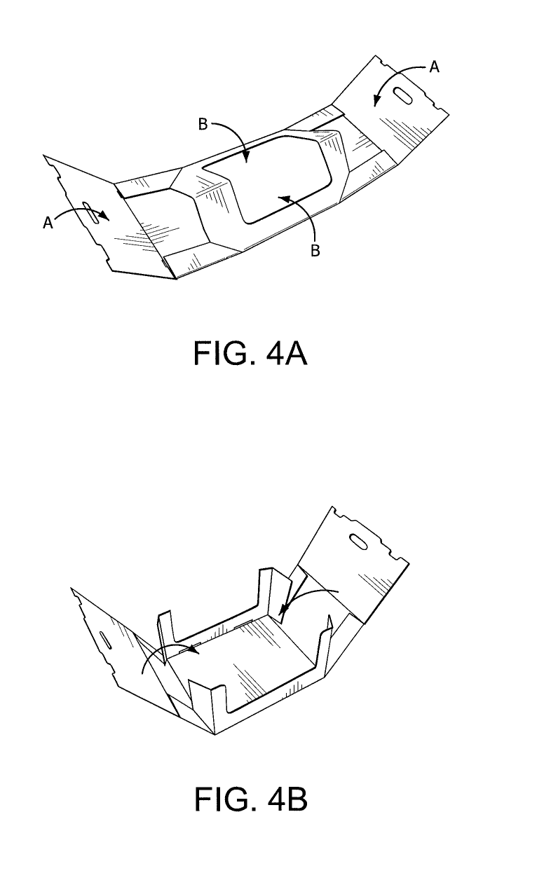

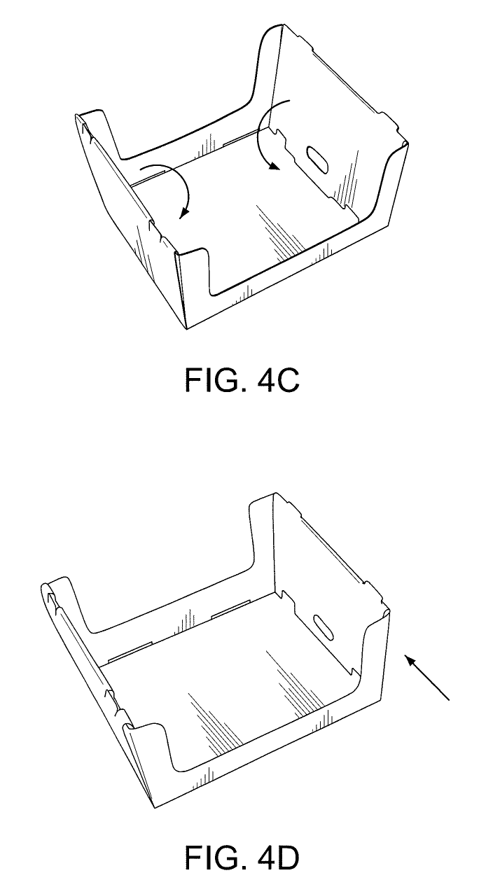

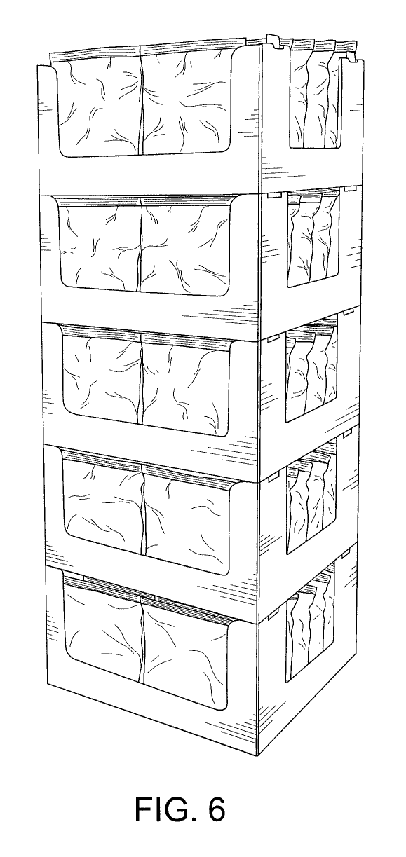

Referring to FIGS. 1-3 and 7, box 10 comprises stacking tabs 100 provided along and adjacent scored fold lines 28 and 36 (of FIGS. 1-3) and also scored fold line 44 (of FIG. 1). Stacking tabs 100 extend vertically from assembled box 10. Slots 102 for stacking tabs 100 are provided along and adjacent the edges of bottom panel 20. Slots 102 of an assembled box 10 (as shown in FIGS. 4d, 5c, and 6) are configured to receive corresponding vertically-projecting stacking tabs 100 of an adjacent box 10 when boxes 10 are stacked one on top of the other as shown in FIG. 6.

Referring to FIGS. 1-3 and 7, box 10 comprises locking tabs 150 provided along and adjacent the edges of the outer portion of left side panel 24 and of the outer portion of right side panel 32 (as shown in FIGS. 1-3) and also along and adjacent the edge of outer portion of rear panel 40 (as shown in FIG. 1). Locking tabs 150 are configured to engage with corresponding slots 152 provided in bottom panel 20 when boxes 10 are assembled (as shown in FIGS. 4d, 5c, and 6).

Box 10 is first pre-assembled for shipment and delivery—whether bundled or not. Pre-assembly comprises folding front panel 22 and rear panel 40′, or alternatively inner portion of rear panel 42, inward toward the center of bottom panel 20. In pre-assembly, front panel 22 is folded along scored fold lines 48, 66, and rear panel 40′, or alternatively inner portion of rear panel 42, is folded along scored fold lines 54, 66. Second arm 64 of L-shaped arms 60 is affixed along its inner surface on a glue area to the corresponding facing surface of inner portions of right panel and left panel 26, 34 as shown, for example, in FIGS. 4a, 5a, 5b, 7. This affixation may be accomplished by glue, adhesive, tape (single or double sided), male/female locks, staples, or the like. In an alternative embodiment, there is no affixation after the panels are folded inward during pre-assembly.

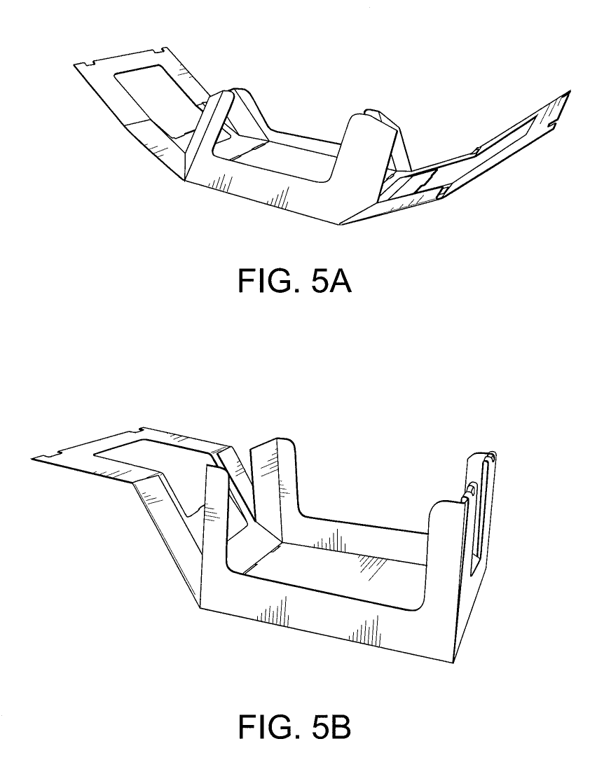

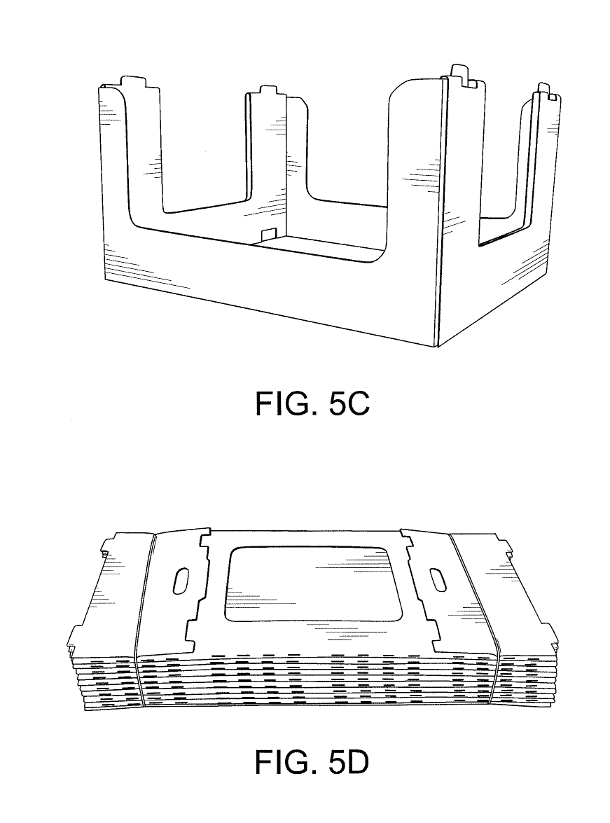

Another optional aspect of pre-assembly of box 10 comprises folding outer portions of right side panel and left side panel 32, 40 inwardly as shown specifically in FIG. 5d. In FIG. 5d, tabs 100 are shown projecting away from the folded right and left side panels in boxes 10 that are preassembled and bundled in a collapsed form. Preassembled boxes 10 are folded flat and easily transportable in this collapsed state.

Another feature of the invention is detailed by FIG. 7. Cutaways 200 are provided as quarter-round communications and facilitate folding of the blank during assembly. Cutaways 200 facilitate ease of folding at a corner by removing cardboard or other material that would bunch while folding and provide a clean edge.

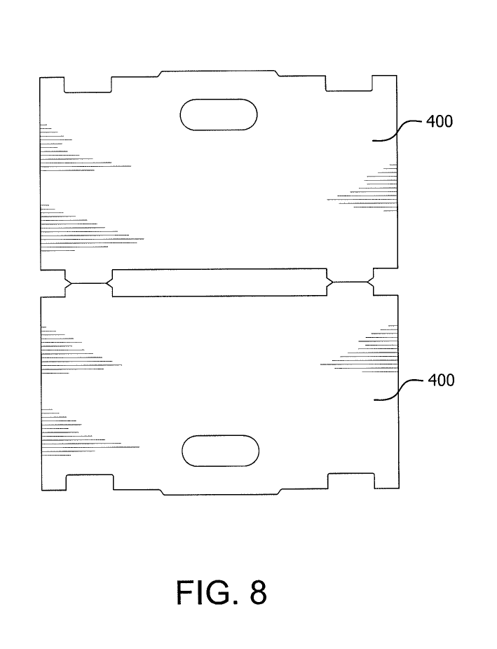

Inserts 400, as shown in FIG. 8, may be provided as added structure for box 10.

After delivery on site at a retailer or merchandiser, preassembled boxes 10 may be finally assembled, stacked, and filled with merchandise. The assembly steps comprise first unfolding outer portions of left and right side panels 24, 32 (as shown in FIGS. 4a—depicted by arrows “A”—and 5a). In the embodiment of the blank of box 10 of FIG. 1, outer portion of rear panel 40 would also be unfolded. The next step is to unfold front panel 22 and inner portion of rear panel 42, or alternatively rear panel 40′, from bottom panel 20 (also shown in FIGS. 4a—depicted by arrows “B”—and 5a). The inner portions of right and left side panels 26, 34 are then folded inward (as shown in FIG. 4b) to create a generally rectangular box-like shape. Outer portions of left and right side panels 24, 32 (and also outer portion of rear panel 40 if this embodiment is being assembled) are then folded downward toward bottom panel 20 (as shown in FIG. 4c), and locking tabs 150 of each panel are engaged with and secured within corresponding slots 152 provided in bottom panel 20 (as shown in FIGS. 4d and 5c). Once boxes 10 are assembled, they may be stacked one on top of the other and stocked with merchandise (as shown in FIG. 6) at a retailer or merchandise location. When stacked, tabs 100 of a box 10 engage slots 102 of box 10 that is stacked on top of it.

In an alternative embodiment, boxes 10 may be fully assembled and filled with merchandise before shipment. In this embodiment, die cutting may be used to provide perforations along edges that define the openings of front panel 22, left and right side panels, and rear panel. This material defined by the perforations would be left partially attached to box 10 during shipment and delivery. The material could then be removed from box 10 holding merchandise at a retailer or merchandiser site.

Another added benefit of the invention is its modularity. Boxes 10 may be stacked into a stand alone display as shown in FIG. 6. A header may be placed on the upper most box of the stack whereby tabs 100 of this box 10 engage slots of header to secure header to the display.

A further benefit of the invention is that its structural features allow each box 10 to hold about 20-30% more product than existing display systems.

Yet another benefit is that the inventions can be easily disassembled and stored in a compact form for later use or discarded.

Another aspect of the invention is to provide a display that may be customized with graphic designs to create a display specific for a manufacturer, retailer, or merchant to deploy and display merchandise for sale. Customization may occur by printing a blank for box 10 with graphics, logos, trademarks, and other information before or after die-cutting of the blanks.

While the invention has been described above in conjunction with specific embodiments, it is evident that many alternatives, modifications, permutations, and variations will become apparent to those skilled in the art in light of the foregoing description. Accordingly, it is intended that the present invention embraces all such alternatives, modifications, and variations as fall within the scope of the claims below.

What is claimed is:

1. A display box comprising:
a generally rectangular configuration defined by a bottom panel, two side panels, a front panel, and rear panel;
two L-shaped attachments contiguous with each side panel;
a plurality of tabs provided along a top edge of the side panels, the front panel, and the rear panel;
a plurality of slots provided in the bottom panel; and
at least two locking tabs provided along edges of the two side panels, wherein the locking tabs are engaged within locking tab slots of the bottom panel.

2. The display box of claim 1 wherein at least one opening is provided in any one of the side panels, the front panel, or the rear panel.

3. The display box of claim 2 wherein at least one opening is provided in the front panel and the rear panel.

4. The display box of claim 2 wherein at least one opening is provided in the front panel, the rear panel, and the side panels.

5. The display box of claim 1 wherein each side panel comprises an upper portion that folds along a score line to contact a lower portion contiguous with the bottom portion.

6. The display box of claim 1 wherein the rear panel comprises an upper portion that folds along a score line to contact a lower portion contiguous with the bottom portion.

7. The display box of claim 1 wherein a portion of the L-shaped attachments contiguous along a scored fold line with the side panels is affixed to the side panels.

8. A method for assembling a display box comprising:
positioning a front panel and a rear panel of the display box at about 90 degrees from a bottom panel of the display box;
positioning two side panels of the display box at about 90 degrees from the bottom panel by bending scored fold lines of L-shaped attachments, wherein the scored fold lines extend away from a center portion of the bottom panel, and wherein the front panel and the rear panel are connected by the L-shaped attachments to the two side panels; and
securing locking tabs of at least the two side panels in slots provided in the bottom panel.

9. The method of claim 8 wherein the method comprises securing locking tabs of the rear panel in slots provided in the bottom panel.

10. The method of claim 8 wherein the method comprises folding an upper portion of each side panels along a score line to substantially contact a lower portion of each side panel.

11. The method of claim 8 wherein the method comprises folding an upper portion of the rear panel along a score line to substantially contact a lower portion of the rear panel.

12. The method of claim 8 wherein at least one portion of each L-shaped attachment is affixed along a surface to corresponding facing surfaces of the side panels.
